(19) United States
(12) Patent Application Publication
(10) Pub. No.: US 2022/0099116 A1
(43) Pub. Date: Mar. 31, 2022

(54) TUBE CLAMP SOCKET

(71) Applicant: Christopher Holshu, Canton, OH (US)

(72) Inventor: Christopher Holshu, Canton, OH (US)

(21) Appl. No.: 17/485,806

(22) Filed: Sep. 27, 2021

Related U.S. Application Data
(60) Provisional application No. 63/084,135, filed on Sep. 28, 2020.

(51) Int. Cl. F16B 2/04

(52) U.S. Cl. CPC F16B 2/04

(57) ABSTRACT

A tube clamp socket, including a socket body, including a cylindrical surface, a first slot disposed on at least a portion of the cylindrical surface to receive a first portion of at least one fastener therein, a second slot disposed on at least a portion of the cylindrical surface to receive a second portion of the at least one fastener therein, and a fastener receiving aperture may be disposed within at least a portion of an interior of the cylindrical surface to receive a center portion of the at least one fastener therein, and an attachment body removably connected to the cylindrical surface to contact the first portion and the second portion of the at least one fastener to prevent the first portion and the second portion of the at least one fastener from moving away from the first slot and the second slot.

### CROSS REFERENCE TO RELATED APPLICATION

This application claims the benefit of, and incorporates by reference, U.S. provisional patent application Ser. No. 63/084,135, entitled “Tube Clamp Socket,” which was filed on Sep. 28, 2020.

### BACKGROUND

### 1. Field

The present general inventive concept relates generally to a socket, and particularly, to a tube clamp socket.

### 2. Description of the Related Art

Food processing is an important procedure in food production and is often used to transform agricultural products into food. Much of this food is processed using a series of tubes and hand-tightened clamps. However, a tightening ability of hands of a person is often limited as a result of age and/or ailments afflicting the joints (i.e. rheumatoid arthritis). As such, the tubes may be inadequately tightened and are prone to leakage.

Sometimes wingnut sockets are used in food processing to connect the tubes and reduce leakage. However, a typical wingnut is between 1/16″ to ¼″ thick, which is too small for food industry usage. Most food processing tubes require ⅜″ to ⅝″ thick wingnuts, making standard wingnuts unsuitable for food processing.

Therefore, there is a need for a socket that connects to a tube clamp and can be tightened or loosened using a wrench.

### SUMMARY

The present general inventive concept provides a tube clamp socket.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a tube clamp socket, including a socket body, including a cylindrical surface, a first slot disposed on at least a portion of the cylindrical surface to receive a first portion of at least one fastener therein, a second slot disposed on at least a portion of the cylindrical surface to receive a second portion of the at least one fastener therein, and a fastener receiving aperture may be disposed within at least a portion of an interior of the cylindrical surface to receive a center portion of the at least one fastener therein, and an attachment body removably connected to the cylindrical surface to contact the first portion and the second portion of the at least one fastener to prevent the first portion and the second portion of the at least one fastener from moving away from the first slot and the second slot.

The first slot and the second slot may be recessed with respect to an end of the cylindrical surface.

The socket body may further include a square drive receiving aperture to receive at least a portion of a square driver of a socket wrench therein.

The attachment body may include a plurality of arcuate portions, and a plurality of indented portions disposed between each end of the plurality of arcuate portions to form a clover shape with the plurality of arcuate portions.

The attachment body may be magnetic to attract the socket body thereto.

The tube clamp socket may further include a plurality of pins perpendicularly disposed away from the attachment body with respect to a direction to connect the attachment body to the socket body.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1A illustrates an exploded front perspective view of a tube clamp socket, according to an exemplary embodiment of the present general inventive concept;

FIG. 1B illustrates an exploded side perspective view of the tube clamp socket, according to an exemplary embodiment of the present general inventive concept; and

FIG. 2 illustrates a side perspective view of the tube clamp socket, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Tube Clamp Socket 100
Socket Body 110
Cylindrical Surface 111
Base 111a
Top End 111b
First Slot 112
Second Slot 113
Fastener Receiving Aperture 114
Square Drive Receiving Aperture 115
Attachment Body 120
Arcuate Portions 121
Indented Portions 122
Pins 130

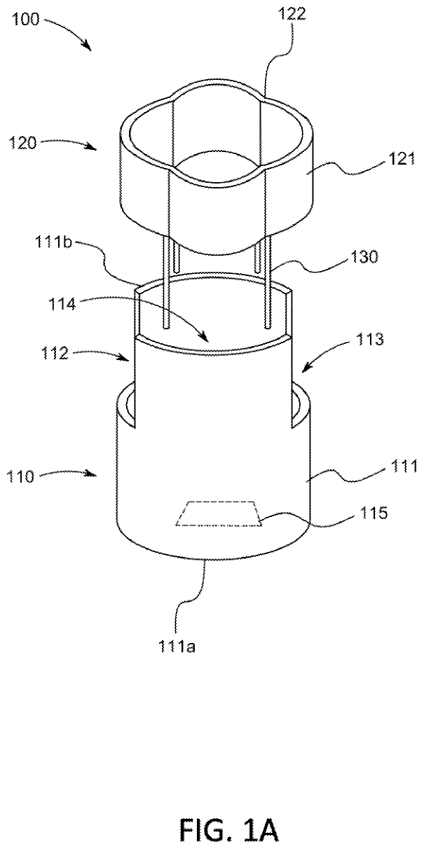

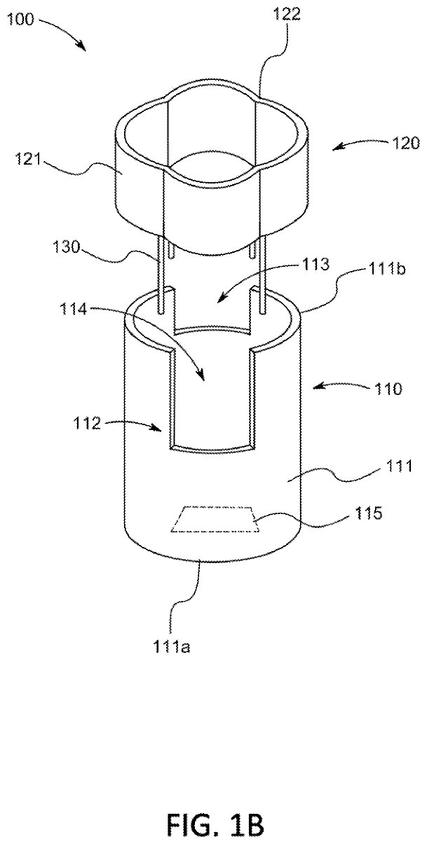

FIG. 1A illustrates an exploded front perspective view of a tube clamp socket 100, according to an exemplary embodiment of the present general inventive concept.

FIG. 1B illustrates an exploded side perspective view of the tube clamp socket 100, according to an exemplary embodiment of the present general inventive concept.

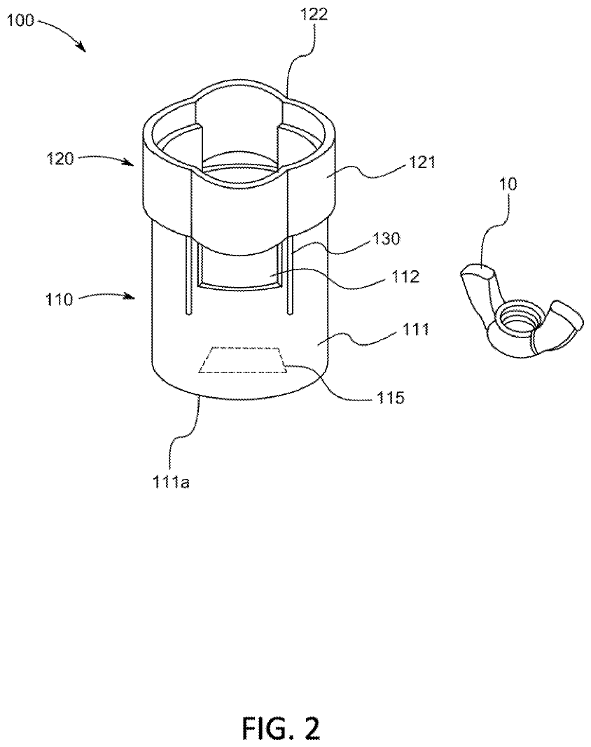

FIG. 2 illustrates a side perspective view of the tube clamp socket 100, according to an exemplary embodiment of the present general inventive concept.

The tube clamp socket 100 may be constructed from at least one of metal, plastic, wood, and rubber, etc., but is not limited thereto.

The tube clamp socket 100 may include a socket body 110, an attachment body 120, and a plurality of pins 130, but is not limited thereto.

Referring to FIGS. 1A through 2, the socket body 110 is illustrated to have a cylindrical shape. However, the socket body 110 may be a rectangular prism, rounded rectangular, circular, conical, triangular, pentagonal, hexagonal, heptagonal, octagonal, or any other shape known to one of ordinary skill in the art, but is not limited thereto.

Also, the socket body 110 may be constructed to be magnetic. In other words, the socket body 110 may attract at least one ferrous item thereto, such as at least one fastener 10. Also, the socket body 110 may have a predetermined size. For example, the socket body 110 may have a length of ⅞ inch. However, the length of the socket body 110 may be greater or less than ⅞ inches based on a size of the at least one fastener 10.

The socket body 110 may include a cylindrical surface 111, a first slot 112, a second slot 113, a fastener receiving aperture 114, and a square drive receiving aperture 115, but is not limited thereto.

The cylindrical surface 111 may include a base 111a and a top end 111b, but is not limited thereto.

The cylindrical surface 111 may have a predetermined diameter corresponding to the size and/or a diameter of the at least one fastener 10, such as a nut and/or a bolt. In other words, the cylindrical surface 111 may vary in size as needed for the at least one fastener 10.

The base 111a may be disposed at a first end of the cylindrical surface 111. The top end 111b may be disposed at a second end of the cylindrical surface 111 opposite to the first end.

The first slot 112 may be disposed on at least a portion of the cylindrical surface 111. Moreover, the first slot 112 may be recessed with respect to the top end 111b. The first slot 112 may have a length greater than half the length of the socket body 110. For example, the length of the first slot 112 may be ⅝″. However, the length of the first slot 112 may be greater or less than ⅝″ based on the size of the at least one fastener 10. For example, the length of the first slot 112 may correspond to a length of a first wing of a wingnut, butterfly nut, wing screw, and/or wing bolt. In other words, the first slot 112 may receive the first wing of the wingnut therein.

The second slot 113 may be disposed on at least a portion of the cylindrical surface 111 opposite with respect to the first slot 112. Moreover, the second slot 113 may be recessed with respect to the top end 111b. The second slot 113 may have a length greater than half the length of the socket body 110. For example, the length of the second slot 113 may be ⅝″. However, the length of the second slot 113 may be greater or less than ⅝″ based on the size of the at least one fastener 10. For example, the length of the second slot 113 may correspond to a length of a second wing of the wingnut, butterfly nut, wing screw, and/or wing bolt. In other words, the second slot 113 may receive the second wing of the wingnut therein.

The fastener receiving aperture 114 may be disposed within at least a portion of an interior of the cylindrical surface 111. The fastener receiving aperture 114 may receive the at least one fastener 10 therein. More specifically, the fastener receiving aperture 114 may receive the wingnut therein, such that first slot 112 may prevent the first wing of the wingnut from moving therefrom, and the second slot 113 may prevent the second wing of the wingnut from moving therefrom. In other words, the top end 111b of the cylindrical surface 111 may be directed toward the at least one fastener 10.

The square drive receiving aperture 115 may be disposed on and/or within at least a portion of the base 111b of the socket body 110. The square drive receiving aperture 115 may receive at least a portion of a square driver of a socket wrench therein. In other words, the socket body 110 may connect to the socket wrench via the square drive receiving aperture 115.

Referring again to FIGS. 1A through 2, the square drive receiving aperture 115 is illustrated to be square shaped. However, the square drive receiving aperture 115 may be rectangular, circular, triangular, pentagonal, hexagonal, heptagonal, octagonal, or any other shape known to one of ordinary skill in the art, but is not limited thereto.

The attachment body 120 may include a plurality of arcuate portions 121 and a plurality of indented portions 122, but is not limited thereto.

Referring again to FIGS. 1A through 2, the attachment body 120 is illustrated to have a clover shape. However, the attachment body 120 may be a rectangular prism, rounded rectangular, circular, cylindrical, conical, triangular, pentagonal, hexagonal, heptagonal, octagonal, or any other shape known to one of ordinary skill in the art, but is not limited thereto.

Each of the plurality of arcuate portions 121 may be arcuately disposed with respect to each of the plurality of indented portions 122. In other words, the plurality of indented portions 122 may be disposed between and/or correspond to each end of the plurality of arcuate portions 121. As such, the plurality of arcuate portions 121 and/or the plurality of indented portions 122 may form a clover shape.

The attachment body 120 may be removably connected to the top end 111b of the cylindrical surface 111. Moreover, the attachment body 120 may contact at least a portion of the at least one fastener 10 therein. For example, the attachment body 120 may contact at least a portion of the first wing and/or the second wing of the wingnut to prevent the first wing and/or the second wing of the wingnut from moving (i.e. slipping) away from the first slot 112 and/or the second slot 113, respectively. In other words, the attachment body 120 may reduce an area of space around the first slot 112 and/or the second slot 113, such that attachment body 120 may connect to the at least one fastener 10.

Furthermore, the attachment body 120 may be magnetic to attract the socket body 110 thereto.

The plurality of pins 130 may be perpendicularly disposed away from the attachment body 120 with respect to a direction. More specifically, each of the plurality of pins 130 may be perpendicularly disposed away from at least one of the plurality of indented portions 122 with respect to the direction. The plurality of pins 130 may extend at least a portion of the length of the cylindrical surface 111 to connect the attachment body 120 to the socket body 110. In other words, the plurality of pins 130 may prevent the attachment body 120 from moving away from (i.e. off) the socket body 110 by increasing friction against the cylindrical surface 111.

Also, the plurality of pins 130 may extend a length less than the length of the cylindrical surface 111. For example, the length of each of the plurality of pins 130 may be ⅛ inches. Furthermore, the plurality of pins 130 may be magnetic to attract the socket body 110 thereto.

Therefore, the tube clamp socket 100 may connect to a tube clamp and facilitate tightening and/or loosening of the at least one fastener 10 on the tube clamp using a socket wrench. Additionally, the tube clamp socket 100 may prevent slipping of the at least one fastener 10 during tightening and/or loosening.

The present general inventive concept may include a tube clamp socket 100, including a socket body 110, including a cylindrical surface 111, a first slot 112 disposed on at least a portion of the cylindrical surface 111 to receive a first portion of at least one fastener 10 therein, a second slot 113 disposed on at least a portion of the cylindrical surface 111 to receive a second portion of the at least one fastener 10 therein, and a fastener receiving aperture 114 may be disposed within at least a portion of an interior of the cylindrical surface 111 to receive a center portion of the at least one fastener therein, and an attachment body 120 removably connected to the cylindrical surface 111 to contact the first portion and the second portion of the at least one fastener 10 to prevent the first portion and the second portion of the at least one fastener 10 from moving away from the first slot 112 and the second slot 113.

The first slot 112 and the second slot 113 may be recessed with respect to an end of the cylindrical surface 111.

The socket body 110 may further include a square drive receiving aperture 115 to receive at least a portion of a square driver of a socket wrench therein.

The attachment body 120 may include a plurality of arcuate portions 121, and a plurality of indented portions 122 disposed between each end of the plurality of arcuate portions 121 to form a clover shape with the plurality of arcuate portions 121.

The attachment body 120 may be magnetic to attract the socket body 110 thereto.

The tube clamp socket 100 may further include a plurality of pins 130 perpendicularly disposed away from the attachment body 120 with respect to a direction to connect the attachment body 120 to the socket body 110.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A tube clamp socket, comprising:
a socket body, comprising:
a cylindrical surface,
a first slot disposed on at least a portion of the cylindrical surface to receive a first portion of at least one fastener therein,
a second slot disposed on at least a portion of the cylindrical surface to receive a second portion of the at least one fastener therein, and
a fastener receiving aperture may be disposed within at least a portion of an interior of the cylindrical surface to receive a center portion of the at least one fastener therein; and
an attachment body removably connected to the cylindrical surface to contact the first portion and the second portion of the at least one fastener to prevent the first portion and the second portion of the at least one fastener from moving away from the first slot and the second slot.

2. The tube clamp socket of claim 1, wherein the first slot and the second slot are recessed with respect to an end of the cylindrical surface.

3. The tube clamp socket of claim 1, wherein the socket body further comprises:
a square drive receiving aperture to receive at least a portion of a square driver of a socket wrench therein.

4. The tube clamp socket of claim 1, wherein the attachment body comprises:
a plurality of arcuate portions; and
a plurality of indented portions disposed between each end of the plurality of arcuate portions to form a clover shape with the plurality of arcuate portions.

5. The tube clamp socket of claim 1, wherein the attachment body is magnetic to attract the socket body thereto.

6. The tube clamp socket of claim 1, further comprising:
a plurality of pins perpendicularly disposed away from the attachment body with respect to a direction to connect the attachment body to the socket body.
